(19) United States
(12) Patent Application Publication
(10) Pub. No.: US 2019/0090471 A1
(43) Pub. Date: Mar. 28, 2019

(54) SUSPENDABLE INSECT TRAP

(71) Applicant: Evergreen Enterprises of Virginia, LLC, Richmond, VA (US)

(72) Inventors: Paul Maguire, Goochland, VA (US); Fei Qiu, Richmond, VA (US)

(21) Appl. No.: 15/719,407

(22) Filed: Sep. 28, 2017

(51) Int. Cl. A01M 1/10; A01M 1/14

(52) U.S. Cl. CPC A01M 1/10; A01M 1/14

(57) ABSTRACT

An insect trap apparatus that includes a reusable cover member defining a trap chamber, a suspension assembly operatively connected to the cover member to permit suspension of the cover member at a suspension point, and a trap configured to at least one of lure, trap, and collect insects. The trap may be connected to the suspension assembly to permit suspension of the trap inside the trap chamber. An inner surface of the cover member is provided with a coating to prevent adhering of the trap to the cover member when the trap is in an operating position inside the trap chamber.

### TECHNICAL FIELD

Embodiments relate to an insect trap that may be placed in an indoor or an outdoor setting that may be used, for example, for purposes of collecting insects, such as fireflies, or exterminating insects, such as Japanese beetles, wasps or bees. The insect trap includes a reusable cover member defining a trap chamber, a reusable or disposable trap configured to trap and collect insects, and a suspension assembly operatively connected to the cover member to permit suspension of the cover member and the trap at a suspension point. The trap may be removeably connected to the suspension assembly to permit suspension of the trap inside the trap chamber. An inner surface of the cover member may be provided with a coating to prevent the cover member adhering to traps using insect-trapping adhesives when the trap is suspended inside the trap chamber.

### BACKGROUND

insect traps, particularly those for use outdoors, are necessary products, yet are generally unattractive in appearance.

### DRAWINGS

The summary of embodiments, as well as the detailed description is better understood when read in conjunction with the accompanying drawings that illustrate one or more possible embodiments of embodiments, in which:

FIG. 1 is an exploded view of an insect trap apparatus, in accordance with embodiments.

FIG. 2 is a front view of an insect trap apparatus, in accordance with embodiments.

FIG. 3 is a front view of the insect trap apparatus of FIG. 1, in which the seam is in an open state.

FIG. 4 is a front view of an upper portion of the insect trap apparatus of FIG. 4.

FIG. 5 is a top view of the insect trap apparatus of FIG. 1.

FIG. 6 is a bottom view of the insect trap apparatus of FIG. 1.

FIG. 7 is a side view of a cross-section of the coating on the inner surface of the cover member, in accordance with embodiments.

FIG. 8 is a front view of an embodiment of a trap for the insect trap apparatus, in accordance with embodiments.

FIG. 9 is a perspective view of an embodiment of a trap for the insect trap apparatus, in accordance with embodiments.

### DESCRIPTION

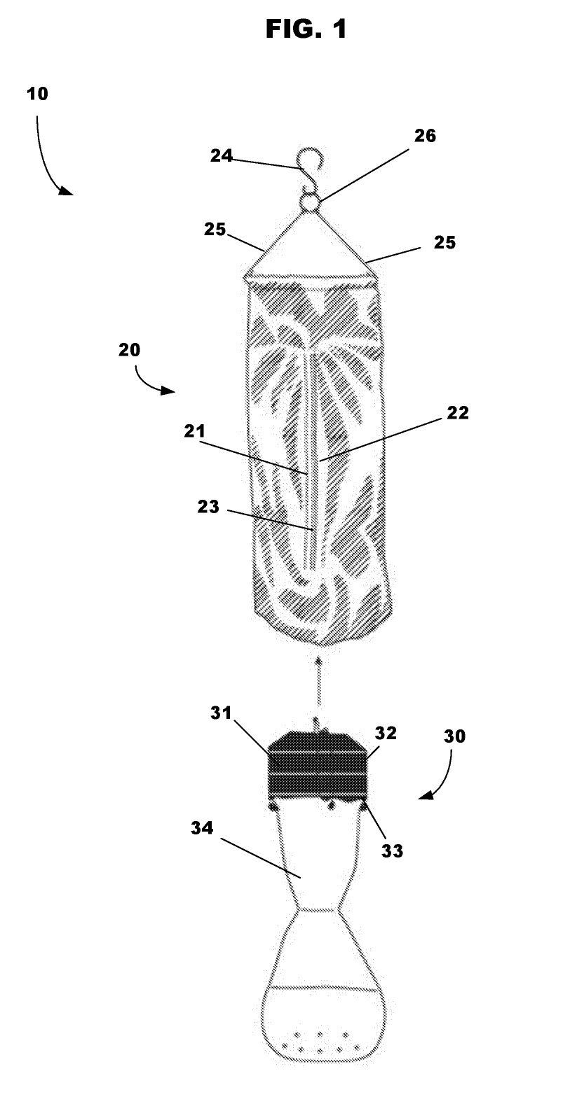

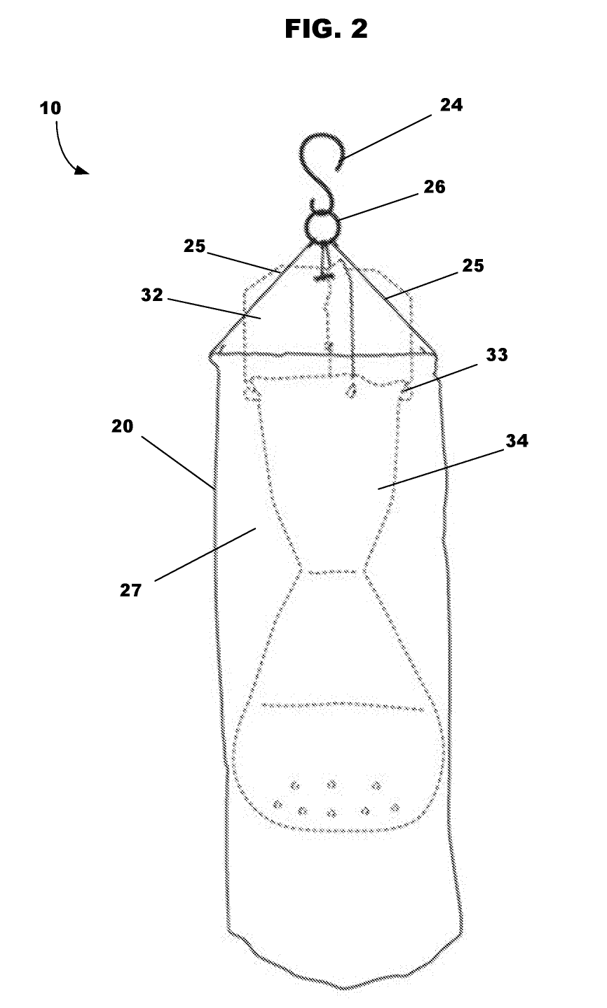

As illustrated in FIGS. 1 and 2, an insect trap apparatus 10 is provided in accordance with embodiments, that may be placed in an indoor or an outdoor setting. The insect trap apparatus 10 comprises a reusable cover member 20 and a reusable or disposable trap 30 configured to lure, and trap insects, and then retain the collected insects. Embodiments may also, alternatively or additionally, include a trap used for the purposes of luring, exterminating, and collecting exterminated insects for later disposal.

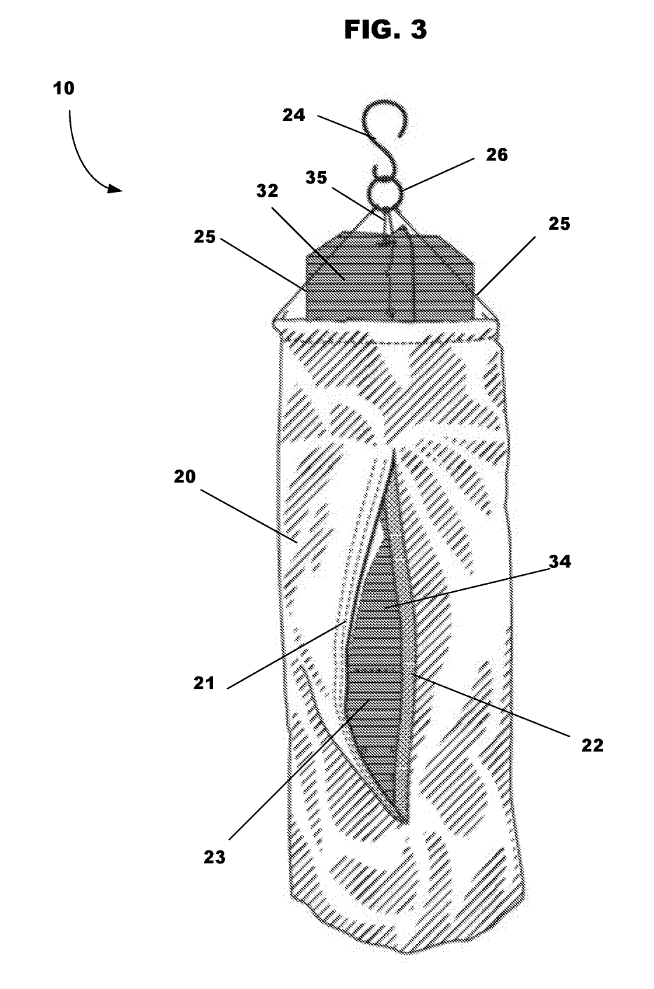

The cover member 20 may comprise a tubular cross-section, such as, for example, a windsock. The cover member 20 is not limited to a tubular cross-section, and may encompass a cross-section that falls within the spirit and scope of the principles of this disclosure. The cover member 20 defines a trap chamber 27 which is to receive the trap 30. The cover member 20 has an opening at a first end thereof, a first longitudinal edge 21 and a second longitudinal edge 22 defining a longitudinal seam 23 which permits access to the trap chamber 27. A mechanical connector or fastener may be provided to removably connect the first longitudinal edge 21 and the second longitudinal edge from a position which closes the trap chamber 27 (FIG. 1), and to a position which exposes the trap chamber 27 (FIG. 3). Such a connector may include at least one of a hook and loop fastener connector, a zipper, and at least one button arranged on at least one of the first longitudinal edge 21 and the second longitudinal edge 22. Embodiments, however, are not limited thereto, and may encompass alternative fasteners that fall within the spirit and scope of the principles of this disclosure.

While the cover member 20 may be composed of a material such as a polymer, fabric or combinations thereof, embodiments are not limited thereto, and may encompass alternative materials and combinations that fall within the spirit and scope of the principles of this disclosure. Such a material may be configured to mask or hide the presence of at least a portion of the trap 30 when the trap 30 is suspended inside the trap chamber 27. The cover member 20 may also include decorative indicia provided on an outside surface thereof.

A suspension assembly is operatively connected to the first end of the cover member 20 to permit suspension of the cover member 20 and the trap 30, and thus, the assembled insect trap apparatus 10, at a suspension point. The suspension assembly comprises at least one first suspension member 24 such as, for example, a hook which is connected to the suspension point, and at least one second suspension member 25 connected at a first end thereof to the cover member 20 and at a second end thereof to the first suspension member 24 via at least one suspension link 26. Although a hook type suspension member 24 is illustrated, embodiments are not limited thereto, and may encompass alternative designs and structural configurations that fall within the spirit and scope of the principles of this disclosure. As an example, additionally or alternatively, embodiments may include a suspension assembly that includes a mechanical connector such as a carbineer to which the suspension members 25, 35 of the cover member 20 and the trap 30 may connect directly. As an example, additionally or alternatively, the suspension members 25 may be connected to the cover 20 at a connection point, in which the suspension members 25 comprise a hook and the cover 20 has suspension points that define the connection point and which are to receive a corresponding hook of the suspension 25.

The trap 30 may comprise a trap body 31 and a trap container 34 operatively connected, in an operative position, to the trap body 31 to permit the sanitary collection of trapped insects and/or disposal of exterminated insects.

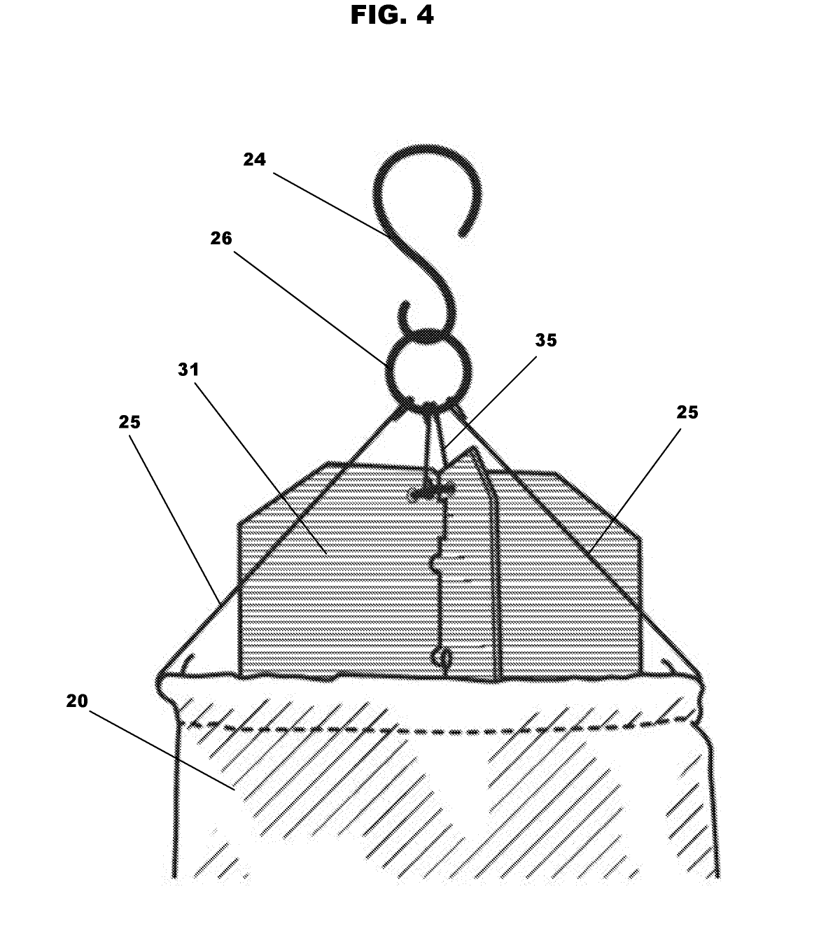

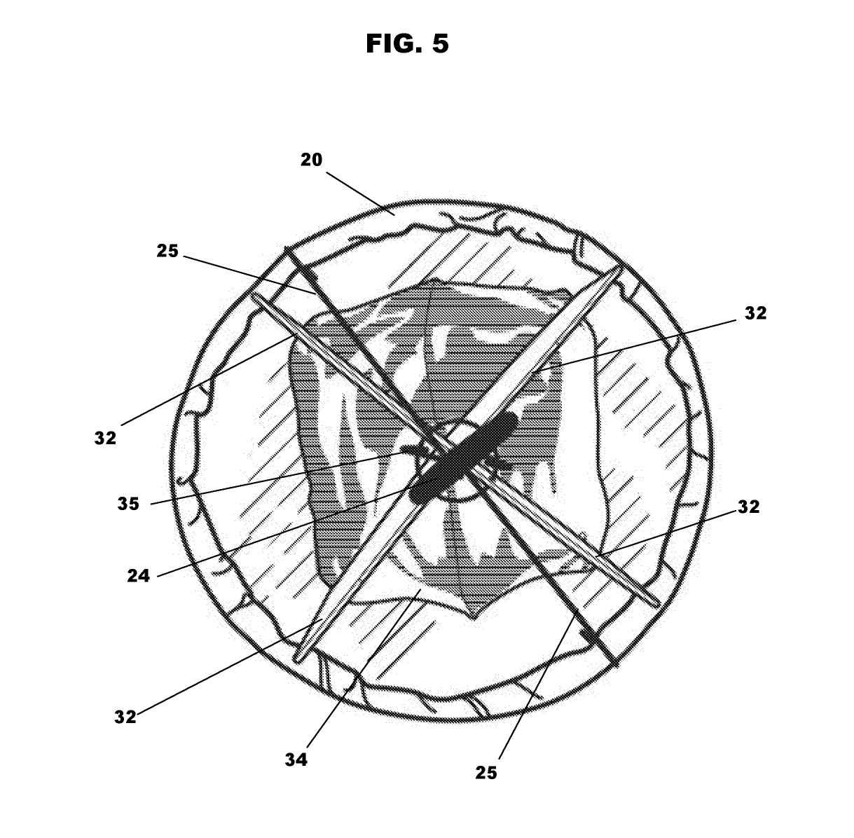

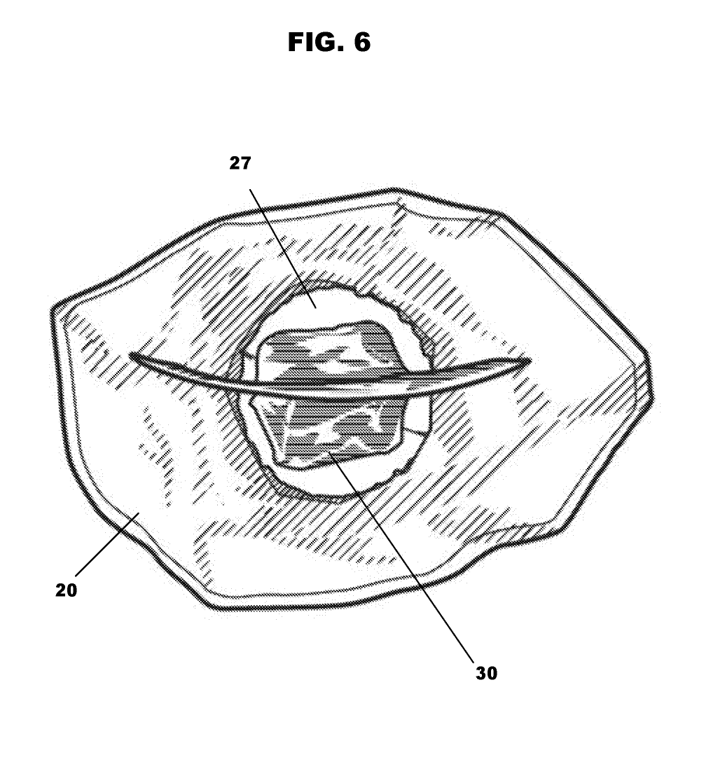

As illustrated in FIGS. 2 through 6, the trap body 31 may comprise a plurality of flaps 32 to connect to form the trap body 31, in an operative position, to the suspension assembly via one or more suspension members 35 which permit suspension of the trap 30 inside the trap chamber 27. A connector such as a hook is provided at a distal end of each flap 32 to permit a connection between the trap body 31 and the trap container 34 to permit removal and disposal of the trap container 34.

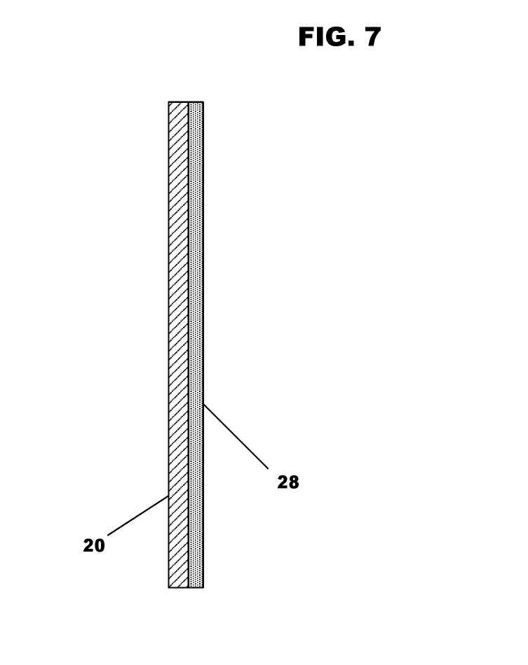

At least one of an outside surface of the trap flaps 32, an inner surface of the trap container 34, and an outer surface of the trap container 34 may be provided with a coating of an attractant, and/or an adhesive, and/or an insecticide configured to at least one of lure, trap, and exterminate insects. An attractant may include specific scent, lure, color, light or other manners intended to attract insects. In this regard, as illustrated in FIG. 7, a coating 28 may be provided on an inner surface of the cover member 20 to prevent adhering of the trap 30 (e.g., the trap body 31 and/or the trap container 34) to the cover member 20 when the trap 30 is in an operating position suspended inside the trap chamber 27. As an example, such a coating may comprise a non-stick coating.

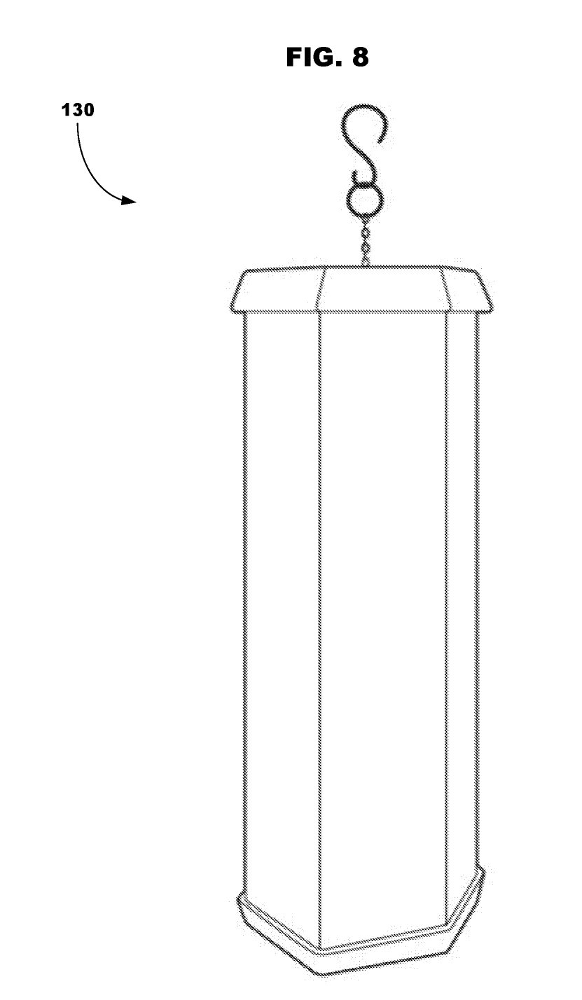

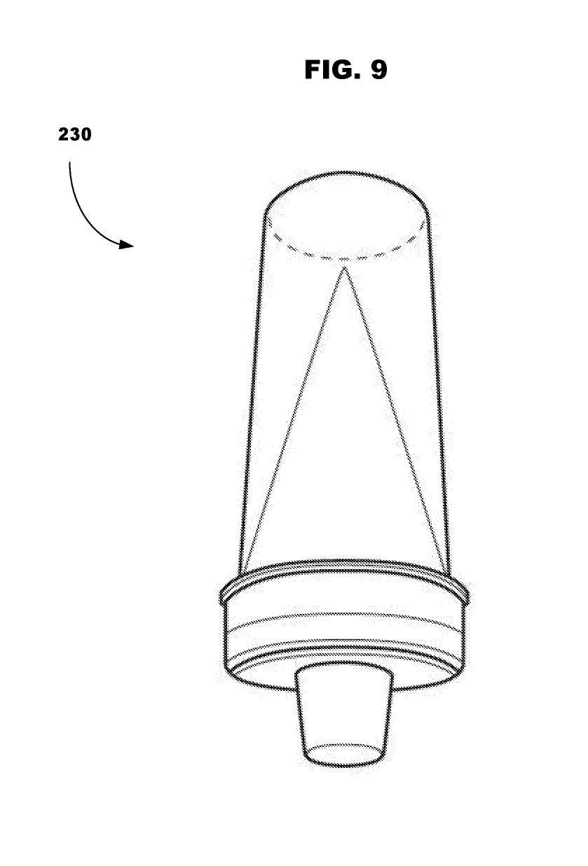

Although embodiments illustrated in FIGS. 1-6 provide for a design of the trap body 31 and trap container 34, embodiments are not limited thereto and may encompass alternative designs and structural configurations that fall within the spirit and scope of the principles of this disclosure. As an example, the trap 30 may be configured in various designs and structural configurations to permit at least one of the luring, trapping, and collecting of specific types of insects. FIGS. 8 and 9 illustrate alternative embodiments of a trap 130, 230 that permits luring, trapping, and collecting of various types of insects. As noted herein, the trap may, alternatively or additionally, be used for purposes of exterminating certain insects.

Additional Notes and Examples:

Example One may include an insect trap apparatus, comprising: a reusable cover member defining a trap chamber, the cover member having an opening at a first end thereof, and a first longitudinal edge and a second longitudinal edge defining a longitudinal seam which permits access to the trap chamber; a trap configured to at least one of lure, trap, and collect insects; and a suspension assembly operatively connected to the first end of the cover member to permit suspension of the cover member at a suspension point, and operatively connected to the trap to permit suspension of the trap inside the trap chamber, the suspension assembly including: (i) a first suspension member removably connected to the suspension point; and (ii) at least one second suspension member removably connected at a first end thereof to the cover member and removably connected at a second end thereof to the first suspension member.

Example Two may include the insect trap apparatus of Example One, wherein the cover member comprises a windsock.

Example Three may include the insect trap apparatus of Example One, wherein the cover member comprises a material configured to mask or hide the presence of at least a portion of the trap when the trap is suspended inside the trap chamber.

Example Four may include the insect trap apparatus of Example One, further comprising decorative indicia provided on an outside surface of the cover member.

Example Five may include the insect trap apparatus of Example One, further comprising a coating on an inner surface of the cover member to prevent adhering of the trap to the cover member when the trap is suspended inside the trap chamber.

Example Six may include the insect trap apparatus of Example Five, wherein the coating comprises a non-stick coating.

Example Seven may include the insect trap apparatus of Example One, further comprising a connector to removably connect the first longitudinal edge and the second longitudinal edge.

Example Eight may include the insect trap apparatus of Example Seven, wherein the connector comprises at least one of a hook and loop fastener connector, a zipper, and at least one button arranged on at least one of the first longitudinal edge and the second longitudinal edge.

Example Nine may include an insect trap apparatus, comprising: a cover member defining a trap chamber, the cover member having a first longitudinal edge and a second longitudinal edge defining a longitudinal seam which permits access to the trap chamber; a trap configured to at least one of lure, trap, and collect insects; and a suspension assembly operatively connected to the cover member to permit suspension of the cover member at a suspension point, and operatively connected to the trap to permit suspension of the trap inside the trap chamber, wherein an inner surface of the cover member is provided with a coating to prevent adhering of the trap to the cover member when the trap is suspended inside the trap chamber.

Example Ten may include the insect trap apparatus of Example Nine, wherein the cover member comprises a windsock.

Example Eleven may include the insect trap apparatus of Example Nine, wherein the cover member comprises a material configured to mask or hide the presence of at least a portion of the trap when the trap is suspended inside the trap chamber.

Example Twelve may include the insect trap apparatus of Example Nine, further comprising decorative indicia provided on an outside surface of the cover member.

Example Thirteen may include the insect trap apparatus of Example Nine, wherein the coating comprises a non-stick coating.

Example Fourteen may include the insect trap apparatus of Example Nine, further comprising a connector to removably connect the first longitudinal edge and the second longitudinal edge.

Example Fifteen may include the insect trap apparatus of Example Fourteen, wherein the connector comprises at least one of a Hook and loop fastener connector, a zipper, and at least one button arranged on at least one of the first longitudinal edge and the second longitudinal edge.

Example Sixteen may include the insect trap apparatus of Example Nine, wherein the suspension assembly comprises: a first suspension member removably connected to the suspension point; and at least one second suspension member removably connected at a first end thereof to the cover member and removably connected at a second end thereof to the first suspension member.

Example Seventeen may include an insect trap apparatus, comprising: a cover member having an outer layer defining a trap chamber, the cover member having an opening at a first end thereof, and a first longitudinal edge and a second longitudinal edge defining a longitudinal seam which permits access to the trap chamber; a suspension assembly operatively connected to the first end of the cover member to permit suspension of the cover member at a suspension point.

Example Eighteen may include the insect trap apparatus of Example Seventeen, wherein the cover member comprises a material configured to mask or hide the presence of at least a portion of the trap when the trap is suspended inside the trap chamber

Example Nineteen may include the insect trap apparatus of Example Seventeen, further comprising a trap configured to at least one of lure, trap, and collect insects, the trap being removeably connected to the suspension assembly to permit suspension of the trap inside the trap chamber.

Example Twenty may include the insect trap apparatus of Example Nineteen, wherein an inner surface of the cover member is provided with a non-stick coating to prevent adhering of the trap to the cover member when the trap is suspended inside the trap chamber.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### REFERENCE NUMERALS

10 Insect trap apparatus

20 Cover member

21 1st edge

22 2nd edge

23 Seam

24 1st suspension member

25 2nd suspension member(s)

26 Suspension link

27 Trap chamber

28 Coating

30 Trap

31 Trap body

32 Trap body flaps

33 Trap body hooks

34 Trap container

35 Trap suspension member(s)

130 Alternate trap

230 Alternate trap

What is claimed is:

1. An insect trap apparatus, comprising:
a reusable cover member defining a trap chamber, the cover member having an opening at a first end thereof, and a first longitudinal edge and a second longitudinal edge defining a longitudinal seam which permits access to the trap chamber;
a trap configured to at least one of lure, trap, and collect insects; and
a suspension assembly operatively connected to the first end of the cover member to permit suspension of the cover member at a suspension point, and operatively connected to the trap to permit suspension of the trap inside the trap chamber, the suspension assembly including:
a first suspension member removably connected to the suspension point; and
at least one second suspension member removably connected at a first end thereof to the cover member and removably connected at a second end thereof to the first suspension member.

2. The insect trap apparatus of claim 1, wherein the cover member comprises a windsock.

3. The insect trap apparatus of claim 1, wherein the cover member comprises a material configured to mask or hide the presence of at least a portion of the trap when the trap is suspended inside the trap chamber.

4. The insect trap apparatus of claim 1, further comprising decorative indicia provided on an outside surface of the cover member.

5. The insect trap of claim 1, further comprising a coating on an inner surface of the cover member to prevent adhering of the trap to the cover member when the trap is suspended inside the trap chamber.

6. The insect trap of claim 5, wherein the coating comprises a non-stick coating.

7. The insect trap of claim 1, further comprising a connector to removably connect the first longitudinal edge and the second longitudinal edge.

8. The insect trap of claim 7, wherein the connector comprises at least one of a Hook and loop fastener connector, a zipper, and at least one button arranged on at least one of the first longitudinal edge and the second longitudinal edge.

9. An insect trap apparatus, comprising:
a reusable cover member defining a trap chamber, the cover member having a first longitudinal edge and a second longitudinal edge defining a longitudinal seam which permits access to the trap chamber;
a trap configured to at least one of lure, trap, and collect insects; and
a suspension assembly operatively connected to the cover member to permit suspension of the cover member at a suspension point, and operatively connected to the trap to permit suspension of the trap inside the trap chamber;
wherein an inner surface of the cover member is provided with a coating to prevent adhering of the trap to the cover member when the trap is suspended inside the trap chamber.

10. The insect trap apparatus of claim 9, wherein the cover member comprises a windsock.

11. The insect trap apparatus of claim 9, wherein the cover member comprises a material configured to mask or hide the presence of at least a portion of the trap when the trap is suspended inside the trap chamber.

12. The insect trap apparatus of claim 9, further comprising decorative indicia provided on an outside surface of the cover member.

13. The insect trap of claim 9, wherein the coating comprises a non-stick coating.

14. The insect trap of claim 9, further comprising a connector to removably connect the first longitudinal edge and the second longitudinal edge.

15. The insect trap of claim 14, wherein the connector comprises at least one of a Hook and loop fastener connector, a zipper, and at least one button arranged on at least one of the first longitudinal edge and the second longitudinal edge.

16. The insect trap of claim 9, wherein the suspension assembly comprises:
a first suspension member removably connected to the suspension point; and
at least one second suspension member removably connected at a first end thereof to the cover member and removably connected at a second end thereof to the first suspension member.

17. An insect trap apparatus, comprising:
a reusable cover member having an outer layer defining a trap chamber, the cover member having an opening at a first end thereof, and a first longitudinal edge and a second longitudinal edge defining a longitudinal seam which permits access to the trap chamber; and
a suspension assembly operatively connected to the cover member to permit suspension of the cover member at a suspension point.

18. The insect trap apparatus of claim 17, wherein the cover member comprises a material configured to mask or hide the presence of at least a portion of the trap when the trap is suspended inside the trap chamber.

19. The insect trap of claim 17, further comprising a trap configured to at least one of lure, trap, and collect insects, the trap being removeably connected to the suspension assembly to permit suspension of the trap inside the trap chamber.

20. The insect trap of claim 19, wherein an inner surface of the cover member is provided with a non-stick coating to prevent adhering of the trap to the cover member when the trap is suspended inside the trap chamber.
